(19) United States
(12) Patent Application Publication
(10) Pub. No.: US 2024/0349738 A1
(43) Pub. Date: Oct. 24, 2024

(54) DOUGH PRESSING DEVICE

(71) Applicant: QUALSERV SOLUTIONS LLC, Fort Smith, AR (US)

(72) Inventors: Arturo Gonzalez RODRIGUEZ, Lilburn, GA (US); Michael D. POTTER, Fort Smith, AR (US)

(21) Appl. No.: 18/636,590

(22) Filed: Apr. 16, 2024

Related U.S. Application Data
(60) Provisional application No. 63/460,102, filed on Apr. 18, 2023.

(51) Int. Cl. A21C 9/04; A21D 13/31

(52) U.S. Cl. CPC A21C 9/04; A21D 13/31

(57) ABSTRACT

A movable pressing device for preparing dough filled with toppings. The device includes a base, a pivoting mechanism that is fixed to the base and a pressing plate operatively engaged with the pivoting mechanism. The pressing plate is horizontally and vertically movable with respect to the base with the pivoting mechanism. The pressing plate includes an outer edge portion that extends around the pressing plate, the outer edge portion comprises a jagged pattern along a bottom surface thereof, the pressing plate further comprises a central portion of the bottom surface of the pressing plate that extends radially inboard of the outer edge portion and through a center of the pressing plate. The central portion is upwardly recessed above the jagged pattern of the outer edge portion.

### CROSS-REFERENCE TO RELATED APPLICATIONS

This application claims priority from U.S. Provisional Application No. 63/460,102, filed on Apr. 18, 2023, the entirety of which is hereby incorporated by reference herein.

### BACKGROUND

This disclosure relates to equipment used in the preparation of dough for subsequent baking, such as in the preparation of dough for pizzas.

### SUMMARY OF THE INVENTION

A first representative embodiment of the disclosure is provided. The embodiment includes a movable pressing device. The device includes a base comprising a support with a retaining edge, a pivoting mechanism that is fixed to the base, and a pressing plate operatively engaged with the pivoting mechanism. The pressing plate is horizontally movable with respect to the base with movement of the pivoting mechanism, and the pressing plate is vertically movable with respect to the pivoting mechanism, wherein the pressing plate comprises an outer edge portion that extends around an outer circumference of a bottom surface of the pressing plate, the outer edge portion comprises a jagged pattern along a bottom surface thereof about the outer edge portion, the pressing plate further comprises a central portion of the bottom surface of the pressing plate that extends radially inboard of the outer edge portion and through a center of the pressing plate. The device further includes a lever with a pin that pivotably connects the lever to the arm, wherein the lever comprises a handle that extends in a first direction away from pivotable connection, and the lever supports a counterweight on an opposite side of the pin from the handle, wherein the lever is rotatable between a first position were the pressing plate is at its highest vertical position and a second position where the pressing plate is at its lowest vertical position.

Another representative embodiment of the disclosure is provided. The embodiment includes a movable pressing device. The device includes a base comprising a support with a retaining edge, a pivoting mechanism that is fixed to the base, and a pressing plate operatively engaged with the pivoting mechanism. The pressing plate is horizontally movable with respect to the base with movement of the pivoting mechanism, and the pressing plate is vertically movable with respect to the pivoting mechanism, wherein the pressing plate comprises an outer edge portion that extends around an outer circumference of a bottom surface of the pressing plate, the outer edge portion comprises a jagged pattern along a bottom surface thereof about the outer edge portion, the pressing plate further comprises a central portion of the bottom surface of the pressing plate that extends radially inboard of the outer edge portion and through a center of the pressing plate, wherein the central portion is upwardly recessed above the jagged pattern of the outer edge portion.

Another representative embodiment of the disclosure is provided. The embodiment includes a method of preparing dough for a pizza. The method includes: flattening dough to a thickness that is desired for baking as a pizza and preparing the dough so that it is approximately circular; placing an one or more fillings around the flattened dough proximate to an outer circumferential edge of the dough but inboard of the outer circumferential edge a predetermined distance; overlapping the one or more fillings resting upon the flattened dough with the dough portion that forms the outer circumferential edge to cover the elongate string of cheese; pulling the outer circumferential edge of the dough until the pulled outer circumferential edge contacts dough that is radially inboard of the placed string of cheese around the circumference of the dough; placing the flattened dough upon a support of a pressing device, the pressing device comprising: a base that receives the support, a pivoting mechanism comprising an arm, the pivoting mechanism is fixed to the base and operatively supports a pressing plate, the pressing plate is horizontally movable with respect to the base with movement of the pivoting mechanism, between a first horizontal position where the pressing plate is concentrically aligned with the support, and a second horizontal position where the pressing plate is moved away from a position of concentric alignment with the support, the pressing plate comprises an outer edge portion that extends around an outer circumference of a bottom surface of the pressing plate, wherein the outer edge portion comprises a jagged pattern along a bottom surface thereof about the outer edge portion, wherein the pressing plate comprises a central portion of the bottom surface that extends radially inboard of the outer edge portion and through a center of the pressing plate, wherein the central portion is upwardly recessed above the jagged pattern of the outer edge portion, the pivoting mechanism further comprises a lever that is pivotably connected to the arm, wherein rotation of the lever causes the pressing plate to vertically move between a first vertical position where the pressing plate is vertically above the support and a second horizontal position where the pressing plate is vertically lower wherein a portion of the pressing plate is lower than at least a top portion of the support; wherein the flattened dough is placed upon the support when the pressing plate is in the first vertical position and the second horizontal position; manipulating the pivoting mechanism to rotate the pressing plate to the first horizontal position, and manipulating the pivoting mechanism so that the pressing plate lowers to the second vertical position, wherein when in the second vertical position the jagged pattern engages the wrapped dough that initially formed the initial outer circumferential edge of the flattened dough; allowing the jagged pattern to press into the dough, and then manipulating the pivoting mechanism such that the pressing plate returns lifts to first vertical position and rotates to the second horizontal position; and removing the dough from the support.

Advantages of the present disclosure will become more apparent to those skilled in the art from the following description of the preferred embodiments of the disclosure that have been shown and described by way of illustration. As will be realized, the disclosed subject matter is capable of other and different embodiments, and its details are capable of modification in various respects. Accordingly, the drawings and description are to be regarded as illustrative in nature and not as restrictive.

### BRIEF DESCRIPTION OF DRAWINGS

FIG. 1 is a perspective view of a device for preparing dough, and specifically for enclosing pizza dough with fillings included within the dough proximate to an outer circumference of the dough, showing the device in a concentric aligned position and vertically raised position.

FIG. 2 a perspective view of the device of FIG. 1 showing the device in a rotated away second position and vertically raised position.

FIG. 3 is a top view of the device in the position of FIG. 2.

FIG. 4 is a perspective view of the device of FIG. 1 showing the device in a concentric aligned position and a vertically lowered position.

FIG. 5 is a side view of the device in the position of FIG. 4.

FIG. 6 is a sectional side view of the device in the position of FIG. 4.

FIG. 6a is a detail view of detail A of FIG. 6.

FIG. 7 is another perspective view of the device in the position of FIG. 1.

FIG. 7a is another perspective view of the device in the position of FIG. 1.

FIG. 7b is another perspective view of the device in the position of FIG. 1 showing a second aperture (29b) that can receive a stop member to allow the arm to rotate in an opposite direction with respect to the base than the rotation allowed as depicted with the differences between the rotational positions of FIGS. 1 and 2, wherein the stop member in the second aperture would constrain the potential rotation of the arm and pressing plate with respect to the base.

FIG. 8 is another perspective view of the device in the position of FIG. 2.

FIG. 9 is a sectional view of the device in the position of FIG. 2 with the base and support removed.

FIG. 10 is another perspective view of the device in the position of FIG. 2.

FIG. 11 a perspective view of dough with a filling positioned around the circumference of the dough proximate to the outer edge of the dough.

FIG. 12 is a pizza dough where the outer edge of the dough has been wrapped over the fillings and a portion of the dough inboard of the fillings has been compressed by the device of FIG. 1.

FIG. 13 is a side sectional partial view of the device of FIG. 1 in the position of FIG. 1, with a dough with like in FIG. 11 resting upon support of the device, with an optional pan removed.

FIG. 14 is the view of FIG. 13 with the outer edge of the dough wrapped over the filings and the device in the position of FIG. 4 such that the pressing plate contacts and locally compresses the dough below the outer edge portion of the pressing plate.

FIG. 15 is a perspective view of an alternative pressing plate that can be removably fixed with respect to a second shaft (that moves with respect to the arm with pivoting of a lever) with an alternative structure to the structure depicted in FIG. 9.

### DETAILED DESCRIPTION OF THE INVENTION

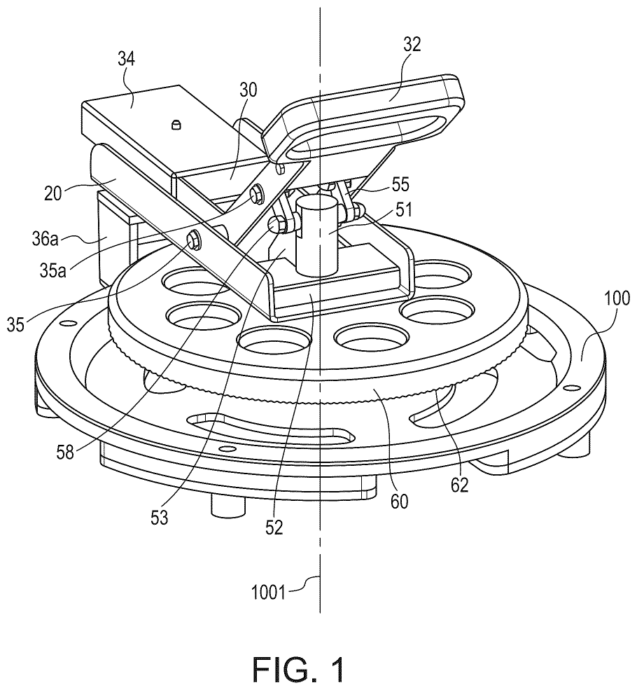

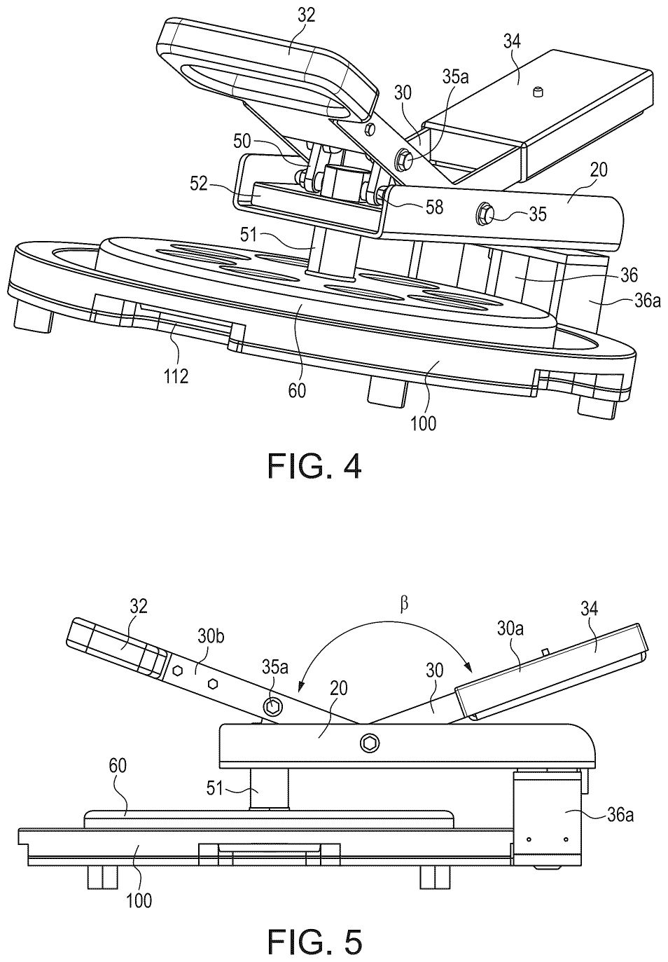

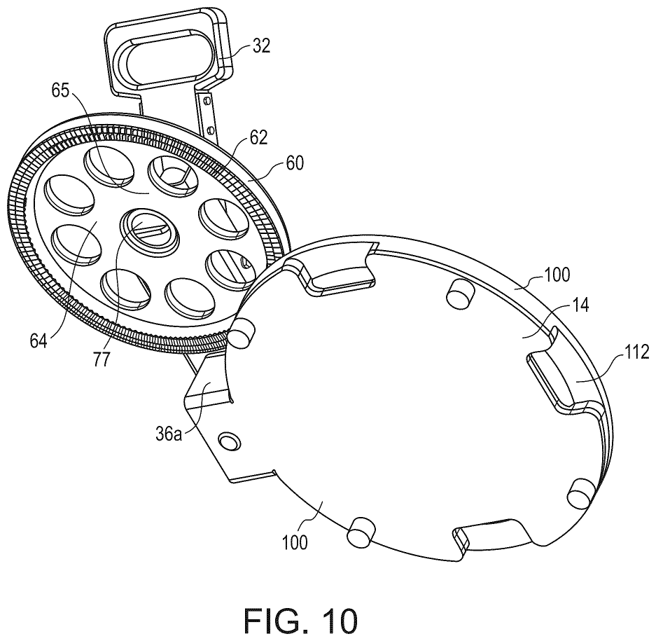

Turning now to FIGS. 1-14 a movable pressing device is provided. The device 10 is specifically configured to be used with uncooked dough, such as pizza dough but alternatively can be used for uncooked dough for other final food products. The device 10 will be described herein as specifically configured for use with pizza dough, and specifically for pizza dough where cheese is deposited and cooked within a crust of the pizza. One of ordinary skill in the art with a thorough review and understanding of the subject specification will readily understand how the device 10 may be modified (e.g. size and shape of various components, or other modifications) in order to be configured for other types of dough.

The device 10 includes a base 14 that rests upon a resting surface (such as a countertop within a restaurant kitchen), and supports a support 100. The support 100 is configured to receive an uncooked pizza dough thereon, typically with the cooked pizza dough 2000 resting upon a pan (not shown). In other embodiments, the uncooked pizza dough may rest directly upon the support 100. The pizza dough 2000 as depicted in the figures is circular, which is specifically defined herein to mean perfectly geometrically circular as well as shapes of dough that are formed to approximate a circle such that a finished and cooked pizza will be generally circular. Those of skill in the art will understand that shapes that aren't perfect circles (i.e. with the outer circumference at all points being the same distance from a center point) would be circular if in the pizza industry those shapes of dough would be considered to be circular enough to be acceptable by a typical customer. For example, the term “approximately circular” as used herein may include perfectly geometrically circular as well as a shape that approximates a circle but with small local differentiations on the exact distance from the outer edge to the center such as is typical with pizzas that are made in circular pans. In other embodiments, the pizza dough may be rectangular or square and the components such as the support 100 and the pressing plate 60 would be sized and shaped in those embodiments to accommodate rectangular or square dough. As with the above, the dough may be “approximately rectangular” or “approximately square” with a similar definition as the definition of approximately circular.

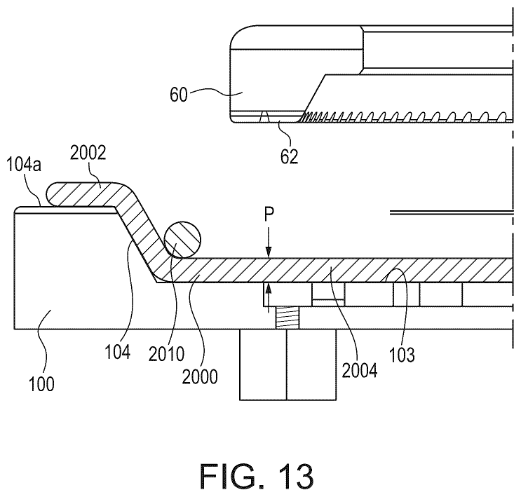

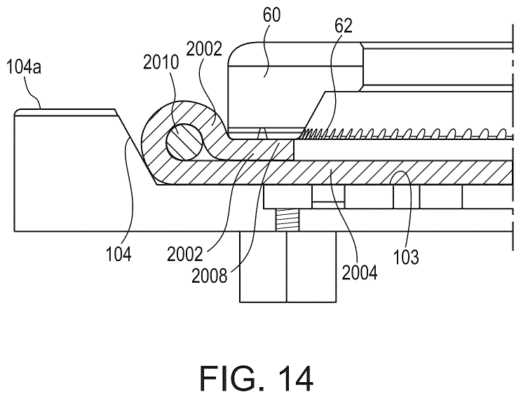

The support 100 includes a resting surface 103 and a retaining edge 104. The resting surface 103 is the surface that receives the dough 2000, either directly or upon a pan (not shown-the pan would be between the dough 2000 and the resting surface 103 in the view of FIGS. 13 and 14). The retaining edge 104 rises above the resting surface 10 and extends about the outer circumference of the support 100. The retaining edge 104 is sized with a larger inner diameter than a final diameter of the dough 2000 (after being folded over to enclose the cheese within the crust-see FIGS. 13 and 14) that is intended to be used with the device 10. The inner edge of the retaining edge 104 may be angled at an obtuse angle with respect to a plane through the resting surface 103 as depicted in the figures. There is a space 102 above the resting surface 103 and inboard of the retaining edge 104 that is configured to receive the dough 2000 therein, and the pressing plate 60 (discussed above) approaches the resting surface within the space 102.

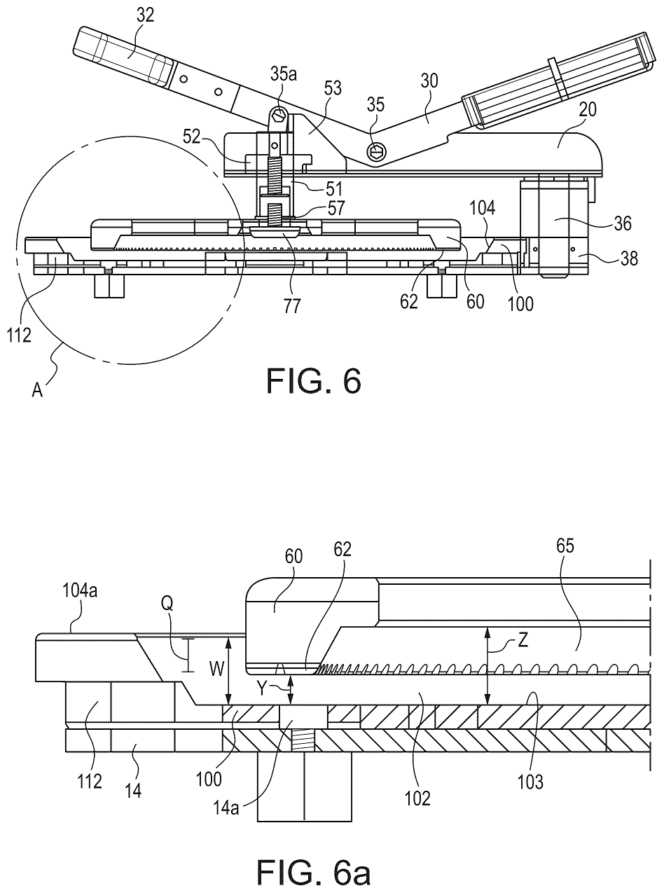

The support 100 may be removably resting upon the base 14. The support may be placed upon a plurality of pins (14a, FIG. 6a) that align the support 14 upon the base 14. The support 100 and base 14 may include complimentary plurality of scalloped portions 112 that allow the user to ergonomically grab the support 100 and lift the support 100 from the base 14, such as to allow the support to be cleaned. FIGS. 6 and 6a are a cross-sectional view of the base 14 and the support 100 (and remainder of the device 10) with the section extending through opposite scalloped portions 112.

The device 10 includes a pivoting mechanism 18 that is fixed to the base 14. The pivoting mechanism 18 supports an arm 20 that is horizontally pivotable with respect to the base 18 between a first aligned position and a second withdrawn position (each discussed below). The pivoting mechanism 18 further includes a lifting mechanism 31 that moves a pressing plate 60 (discussed below) between a first upper position and a second lower position (each discussed below). The device 10 is provided such that the pressing plate 60 can interact with pizza dough positioned upon the support 100 and specifically to press the pizza dough to fully form and lock in the pizza dough that has been folded over cheese positioned upon the dough to form a crust filled with cheese for a pizza to be baked, as discussed below. Specifically, the pressing plate 60 includes an outer edge portion 62 that may include a jagged pattern, with the outer edge portion 62 pressing into the dough 2000 below the pressing plate 60, but the remainder of the pizza dough (i.e. the crust filled with cheese and the portion of the dough radially inward of the outer edge portion 62) is not pressed by the pressing plate 60.

The pivoting mechanism 18 includes a shaft 36 that is fixed to the arm 20 such that the arm 20 rotates as the shaft 36 rotates with respect to the base 14. The shaft 36 is vertically mounted with respect to the base and is rotationally supported by the base to be free to rotate. The base 14 may include a shaft housing 36a that rotatably supports the shaft in one, two or several positions along the shaft 36. The shaft may include one or more pins therethrough that are installed outside of the shaft housing 36a to prevent vertical motion of the shaft 36 with respect to the shaft housing 36a.

In some embodiments, the shaft housing 36a may receive a resistance block 38 with an aperture (not shown specifically, but the shaft 36 extends through the aperture in the resistance block 38 as depicted in the figures) that receives the shaft 36 therethrough. The aperture may be a diameter that is the same as or just smaller than an outer diameter of the shaft 36 such that a tight connection or fit is formed between the shaft 36 and the aperture. This tight connection establishes a normal force onto the shaft 36 as the shaft 36 is rotated with respect to the shaft housing 36 and upon the resistance block 38. The normal force generates friction upon the shaft 36, which provides resistance to rotation of the shaft 36 with respect to the resistance block 38. This resistive frictional force assists with maintaining the arm 20 (and the pressing plate 60 which movable extends from the arm 20) in the current rotational position. The arm 20 can be rotated by the user when the arm is manipulated (typically by the user manipulating the handle 32, as discussed below) but the resistive frictional force prevents the arm, for example, from rotating away from its current position if the arm (or the handle 32) is accidentally bumped. One of ordinary skill in the art with a thorough review of this specification will understand that a tight fit that establishes friction is such that a friction that is generated would be sufficient to result in a tangible restrictive force that would be ergonomically felt by a user that manipulates the handle 32 of the lever 30 (discussed in detail below) to cause the user to feel the resistance, and not simply a force of friction that is always present when two surfaces are urged to slide against each other which may be very minor in magnitude depending upon the coefficient of friction and the forces imparted upon the handle 32).

The resistance block 36a may be a different material than the shaft 36, and in preferred embodiments a softer material than the shaft 36 such that the resistance block 36a will degrade through extended use rather than the shaft 36 degrading. The device 10 can be readily disassembled such that the resistance block 38 can be replaced with a new resistance block if the aperture 36a increases in size with extended use to restore the frictional resistive force with a new resistance block 38 between the shaft 36 and the resistance block 38.

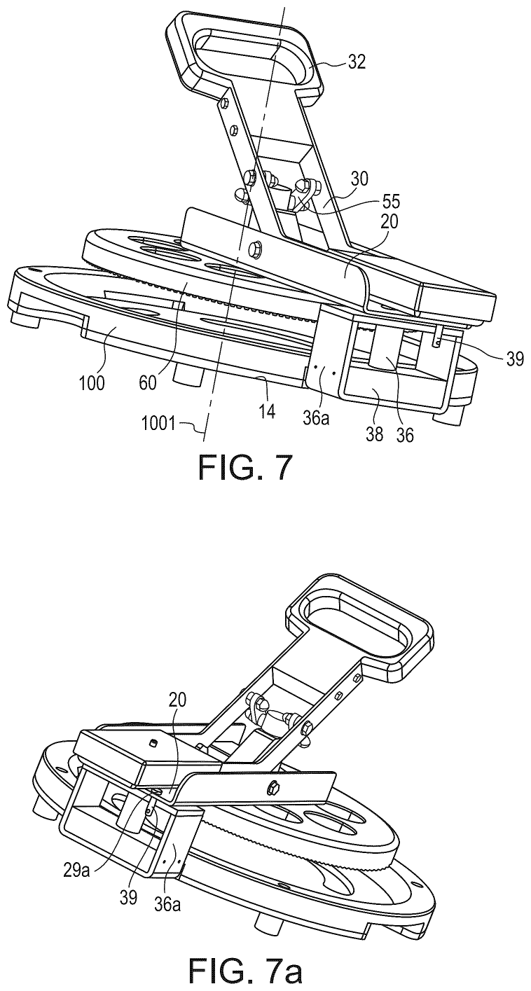

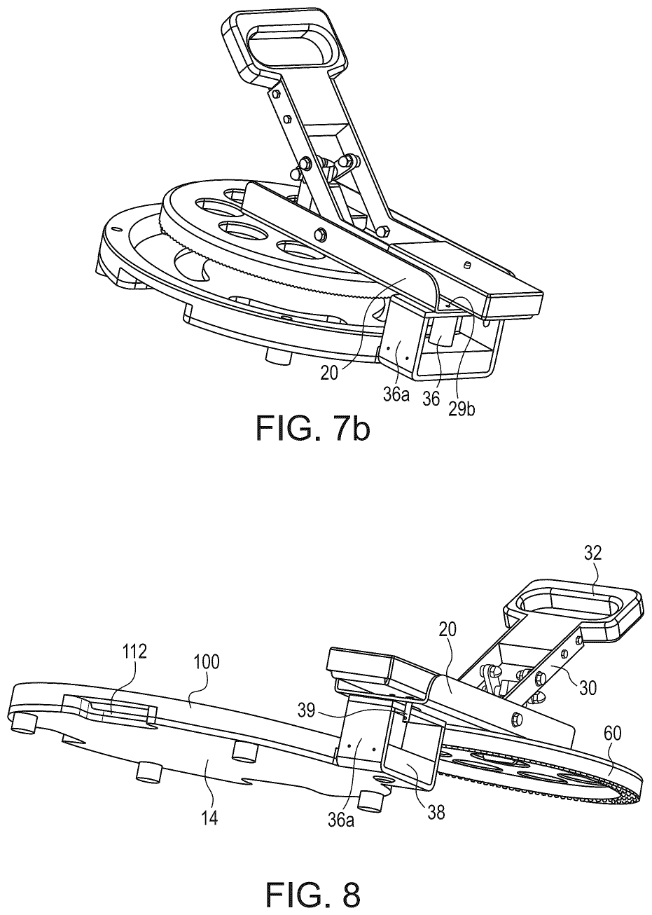

The arm 20 is fixed to the shaft 36, such as with a pinned connection or a tight threaded connection. In some embodiments, the arm 20 may support a stop member 39 that mechanically engages the shaft housing 36a to limit the potential horizontal pivoting travel of the arm 20 (and the shaft 36) with respect to the shaft housing 36a. In some embodiments, as best depicted in FIGS. 7 and 8, the stop member 39 is a pin that extends from the arm and engages the shaft housing 36a when the arm 20 is aligned such that a center of the pressing plate 60 is concentric with a center 106 of the support 100 (axis 1001) and therefore properly aligned with dough 2000 that is upon the support 100. In embodiments where the pressing plate 60 and the dough 2000 are not circular, this position is when the arm 20 is aligned such that the pressing plate 60 is aligned to interact with the dough 2000 within the support as desired, which is also considered within the scope of this disclosure to be “concentric” even with devices 10 designed to interact with different dough shapes (rectangular, square). In some embodiments, the stop member 39 may be positioned upon the arm 20 that it contacts the shaft housing 36a when the arm 20 is in a position where center of the pressing plate is concentric with the center of the support 100, and such that the stop member 39 no longer contacts the shaft housing 36a when the arm 20 moves to move the pressing plate 60 to a horizontally withdrawn position from the support 100. In other embodiments, the stop member 39 may maintain contact with the shaft housing 36a but may be aligned to allow rotational movement of the arm 20 with the contact between the stop member 39 and the shaft housing 36a. In some embodiments, when the arm 20 reaches a horizontal pivoted position where the pressing plate 60 is withdrawn from the support 100, such as when no part of the pressing plate 60 is vertically above the support 100 (or when the pressing plate 60 is moved such that only a minor portion of the pressing plate 60 is vertically above the support 100) the stop member 39 may again contact the shaft housing 36a to prevent further horizontal rotation of the arm 20 in that direction. In this embodiment, the pin 39 constrains the full range of potential horizontal rotation of the arm 20 with respect to the shaft housing 36 and therefore the base 14 (and support 100 which is removably fixed to the base 14). In some embodiments, the stop member 39 contacts the shaft housing 36a at different positions when the arm is in the concentric position and the withdrawn position.

In some embodiments, the stop member 39 is configured to constrain the arm 20 to only one range of potential motion with respect to the shaft housing 36, such as moving the arm 20 in a clockwise direction when moving to the withdrawn position when viewed from above the arm 20 and pressing plate 60, which that the arm 20 and pressing plate 60 is to the left of the support 100 when viewed from above. In other embodiments, the stop member 39 may be differently positioned upon the arm 20 such that in an alternate position, the stop member 39 allows the arm to rotate from the collinear position to a withdrawn position in a counter-clockwise direction such that the arm 20 and pressing plate 60 is located to the right of the support 100 when viewed from above. In this embodiment, the stop member 39 would constrain the rotation of the arm 20 in the opposite rotational direction, and establish the potential travel of the arm 20 with respect to the shaft housing 36a from the collinear position to a withdrawn position.

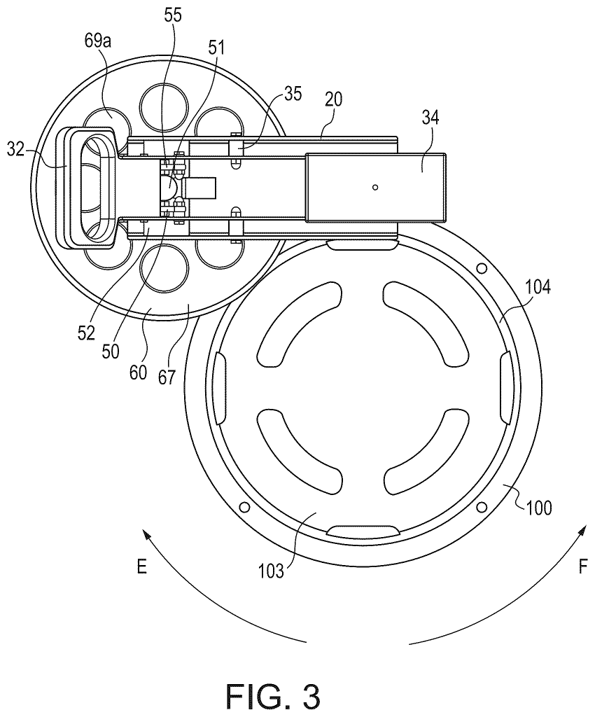

FIG. 7a is another view of the stop member 39 (as depicted in an embodiment where the stop member 39 is a pin that extends from the arm to a position where it interacts with the shaft housing 36a) that depicts the stop member 39 extending through an aperture 29a in the arm 20 such that the pin contacts the shaft housing 36a (when in the in an alternate position upon the arm 20 so that it contacts the shaft housing 36 (when in the concentrically aligned position). As depicted in FIG. 7b, the arm 20 may include a second aperture 29b that is on an opposite side of the arm from the aperture 29a, with the second aperture 29b being capable of receiving the pin 39. As can be understood with reference to FIGS. 7-7b, when the pin 39 is in the second aperture 29b, the pin 39 when the device is in the position of FIG. 7 (concentrically aligned) the pin 39 contacts the shaft housing 36a in a position to prevent rotation of the arm 20 with respect to the shaft housing 36 in the same direction (E, FIG. 3) as the arm 20 can rotate with respect to the shaft housing 36a when the pin 39 extends through the first aperture 29a. When the pin 39 is in the second aperture 29b, the arm 20 is free to pivot in an opposite direction (F, FIG. 3) with respect to the shaft housing 36a, such that the pressing plate 60 would be rotated to the opposite side of the base 14 than the alignment of FIG. 3. IN the embodiment when the pin 39 extends through the second aperture 29b, the pin 39 would contact the shaft housing 36a at a different position to prevent further rotation of the arm 20 with respect to the shaft housing 36 away from the concentric aligned position). Accordingly, when the pin 39 is in the second aperture 29, the engage between the pin 39 and the shaft housing 36a constrains the potential rotation of the arm 20 with respect to the shaft housing 36a (and therefore the base 14 and resting surface 100), but allows the arm to rotate the pressing plate 60 to the opposite side of the base 14 as when the pin 39 is in the first aperture 29a (as depicted in the figures.

In other embodiments, the stop member 39 may alternatively include extensions from the shaft housing 36a that interact with the arm 20 directly to limit the range of travel of the arm 20 with respect to the stop housing 36a.

In still other embodiments, the shaft 36 may have one or more extensions that extend radially from the shaft 36 that interact with portions of the shaft housing 36a when the shaft is at positions corresponding to the collinear position and the desired limit of rotational travel of the arm 20.

The arm 20 supports a lever 30 that can pivot about the arm 20. In these embodiments the arm 20 is capable of rotating horizontally as the shaft 36 rotates, but is fixed in the vertical direction. The lever 30 is pivotably connected to the arm 20, such as with a pinned connection 35.

The lever 30 includes a handle 32 that is configured to be ergonomically operated by the user to cause both vertical and horizontal movement of the pressing plate 60 as discussed herein. As discussed below the lever 30 movably supports the pressing plate 60 such that movement of the handle 32 and therefore the lever 30 to pivot with respect to the arm 20 causes the pressing plate 60 to move vertically upwardly and downwardly.

In some embodiments, the pressing plate 60 is fixed to a shaft 51 that extends upwardly from the pressing plate 60, such as an upper surface of the pressing plate 60. The shaft 51 may be capable of vertically moving as the lever 30 is pivoted by a linkage 50 and physical constraints of the arm 20 or that are fixed to the arm 20. In some embodiments, the lever 30 is constrained with a link 55 with a pinned connection 35a, with the link 55 constrained with the shaft 51 with a second pinned connection 58. Accordingly, pivoting of the lever 30 (due to a force applied to the handle 32) causes the link 55 to feel a force at the pinned connection 35a, with the force applied to the shaft 51 via the second pinned connection 58. In a preferred embodiment, the arm 20 may support a wall 53 that the shaft 51 contacts and maintains contact with as the shaft 51 translates linearly along its range of motion, with the wall 53 constraining the motion of the shaft 51 to linear motion in response to movement of the link 55. Accordingly, the lever 30, the link 55, and the shaft 51 may form a conventional four bar linkage, with the arm 20 (with the wall 52) constraining the linkage and acting as ground with respect to the four bar linkage.

In some embodiments, the lever 30 may include portions (front 30b and rear 30a—front and rear are from the perspective of a user in front of the device 10 when the pressing plate 60 is concentrically aligned with the surface 100) that are aligned at an angle B (FIG. 5) with respect to each other and such that the lever 30, or in some embodiments, structures that are fixed with respect to the lever 30, contact the arm 20 to constrain the possible pivoting motion of the lever 30 with respect to the arm 20 and therefore to constrain the possible vertical motion of the shaft 51 (and pressing plate 60 that is fixed to the shaft 51) as the lever 30 pivots. For example, in the embodiment depicted in the figures, a rear side of the lever 30b (i.e. the side of the lever on the opposite side of the pinned connection 35 from the handle 32) contacts the arm 20 to establish a fully vertical position of the shaft 51 and the pressing plate 60. In this embodiment, the link 55 contacts the structure that is fixed to the arm when the opposite pivot direction to establish the fully lowered vertical position of the shaft 51 and the pressing plate 60. One of ordinary skill in the art with a thorough review and understanding of this disclosure will readily understand that the points of contact between the lever 30 and the arm 20 (and/or structures that are fixed to (or constrained by—such as the constraint between the link 55 and the lever 30 with the pinned connection 35a and the wall 53) either the lever 30 or the arm 20) may alternatively be provided with various shapes, sizes, and points of contact in order the constrain the relative potential motion of the lever 30 (and ultimately the pressing plate 60) with respect to the arm 20, and the design to result in the desired potential range of motion of the pressing plate 60 would be a matter of routine optimization.

In some embodiments, the lever 30 may include a counterweight 34, which may be positioned upon the arm 20 on an opposite side of the pinned connection 35 as the handle 32. The counterweight 34 provides a torque upon the lever 30 that urges the lever 30 to a first position where the pressing plate is in the highest vertical position (via the linkage 50) i.e. a position where the handle 32 is vertically upward. The rear portion 30a (the portion that supports the counterweight 34) contacts the arm 20 when the in the first position, or alternatively, a structure, such as the counterweight 34, that is fixed to the lever 30 contacts the arm 20. The lever 30 is rotatable to a second position, where the counterweight 34 is raised from the arm, and the handle 32 is in the lowest vertical position (and the pressing plate 60 via the linkage 50 is also in the lowest vertical position).

The arm 20 may support a second resistance block 52 that includes an aperture (not specifically shown, but the second shaft 51 extends through the aperture in the second resistance block 52) that receives the second shaft 51 therethrough. The aperture may be a diameter that is the same as or just smaller than an outer diameter of the second shaft 51 such that a tight connection is formed between the second shaft 51 and the aperture. This tight connection establishes a normal force onto the second shaft 51 as the second shaft 51 is vertically translated with respect to the arm 20 and the second resistance block 52 as the lever 30 pivots with respect to the arm 20. The normal force generates friction upon the second shaft 51, which provides resistance to sliding of the second shaft 51 through the aperture of the second resistance block 52. This resistive frictional force assists with maintaining the lever 30 (and the pressing plate 60 which is constrained with respect to the lever 30 with the linkage 50) in the current vertical position. (As with the force of friction generated between the shaft 36 and the first resistance block 38, this force of friction is of a magnitude that would be ergonomically significant and significant to balance out the gravitational force upon the first end portion 30a of the lever 30, and not simply a small force of friction that is always present when two surfaces slide by each other depending upon the coefficients of friction). The lever 30 can be pivoted with respect to the arm by the user when the handle 32 is manipulated (but the resistive frictional force balances the torque upon the lever from the counterweight 34. The frictional force between the second shaft 51 and the second resistance block 52 may be sufficient to prevent the torque upon the lever 30 from the counterweight 34 from causing the lever to rotate from the second position (pressing plate at its lowest vertical position) toward the first position (pressing plate moves upwardly until first portion 30a of lever contacts the arm 20). The second resistance block 52 is called the “second resistance block” herein for the sake of convenience and differentiation from the resistance block 38, but it is possible for the device 10 to include only one of the resistance block 38 or the second resistance block 52, or both of the two resistance blocks 38, 52.

The second resistance block 52 may be a different material than the second shaft 51, and in preferred embodiments a softer material than the second shaft 51 such that the second resistance block 52 will degrade through extended use rather than the second shaft 51 degrading. The device 10 can be readily disassembled such that the second resistance block 52 can be replaced with a new resistance block if the aperture increases in size with extended use to restore the frictional resistive force with a new second resistance block 52 between the second shaft 51 and the second resistance block 52.

The second shaft 51 is described herein as a shaft and is depicted as cylindrical. This part may be rectangular, or with other cross-sectional shapes such that one or several sides to allow for sliding motion and sliding contact between the second shaft 51 and the second resistance block 52 (when provided) as well as the wall 53 to constrain and in some embodiments establish a resistive frictional force when the second shaft 51 is translated.

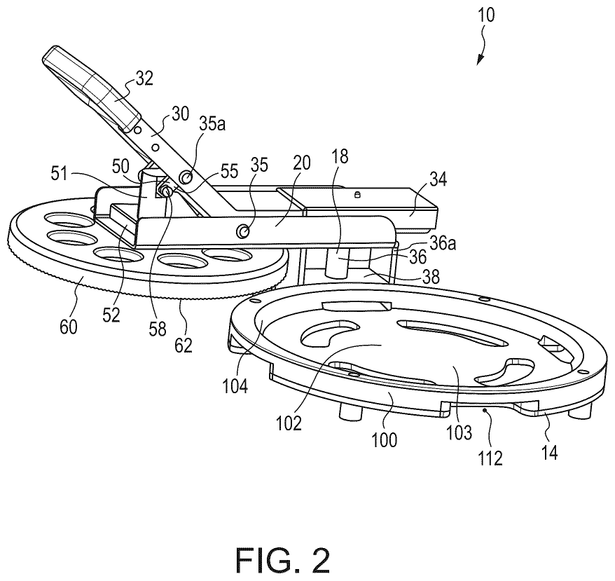

The pressing plate 60 is best shown in FIGS. 2, 6, 6a, and 9. The pressing plate includes an upper surface 67 and a lower surface 64. The pressing plate 60 includes an outer circumferential portion 62 that extends from the outer edge inwardly for a distance but ends significantly from a center 68 of the pressing plate 60. The outer circumferential portion 62 extends vertically lower than the remaining central portion 63 of the bottom surface 64 inboard of the outer circumferential portion 62, and establishes a void 65 within the space below the bottom surface 64 and inboard of the outer circumferential portion 62.

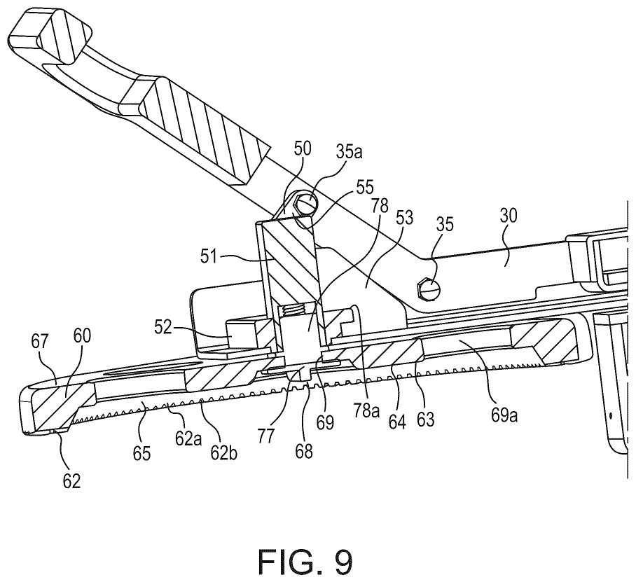

The outer circumferential portion 62 may include a plurality of geometric features that are spaced along the circumference of the portion. In the depicted embodiment, the features are a plurality of ridges 62a and valleys 62b that establish a repeating jagged portion (FIG. 9). The ridges may each extend radially toward the center 68 of the pressing plate 60, or they may be in a uniform direction. Alternatively, the jagged portion may alternatively be a plurality of indentations and recesses that are spaced along the surface in a repeating pattern or an arbitrary or a non-continuous pattern.

The device 10 is configured such that the outer circumferential portion, and specifically the ridges 62a and valleys 62b of the jagged portion is positioned within the space 102 above the resting surface 103 of the support 100 and inboard of the retaining edge 104 and vertically below a top surface 104a of the retaining edge (Q, FIG. 6a). In this position (pressing plate 60 concentric with support 100 and in the lowered position) the jagged portion is, i.e. at least the bottom most tips of the jagged portion, and in some embodiments the entire jagged portion are spaced from the resting surface 103 a distance Y that is smaller than a distance W between a height of the top surface 104a of the retaining surface 104 above the resting surface 103. In some embodiments, as will be discussed in further detail below, the distance W is less than double the thickness of the dough 2000 that is configured to be received upon the resting surface 100, such that when the pressing plate is in the lowered position (FIGS. 6, 6a) the jagged portion locally compresses the folded over dough 2000 that is received upon the resting surface 100 (FIG. 14).

The pressing plate 60 is fixed to the second shaft 51 so that the pressing plate 60 raises and lowers as the second shaft 51 is translated vertically with operation of the linkage 50. The pressing plate 60 may have a center aperture 69 that allows a fastener 77 to pass therethrough to connect to the second shaft 51. In some embodiments, the fastener 77 may be form a threaded connection with the arm for direct contact therebetween. In other embodiments, an intermediate fastener 78 (FIG. 9) may connect to the fastener 77, with the intermediate fastener 78 in turn connecting to the second shaft 51. In the embodiment depicted in FIG. 9, the intermediate fastener 78 makes a threaded connection with the second shaft 51, and the intermediate fastener 78 may make a threaded connection with the fastener 77. The threaded connection between the fastener 77 and the intermediate fastener 78 allows the pressing plate 60 to be easily and readily removed from the connection with (direct or indirect) with the second shaft 51 for ease of removal and reinstallation for cleaning of the pressing plate 60. The intermediate shaft 78, when provided, may include a flange 78a that rests above the pressing plate 60 to assist with aligning the pressing plate 60 when reconnecting the components. In embodiments, when the flange 77 directly connects to the second shaft 51, the second shaft 51 may include a structure similar to the flange 78a to align the pressing plate 60.

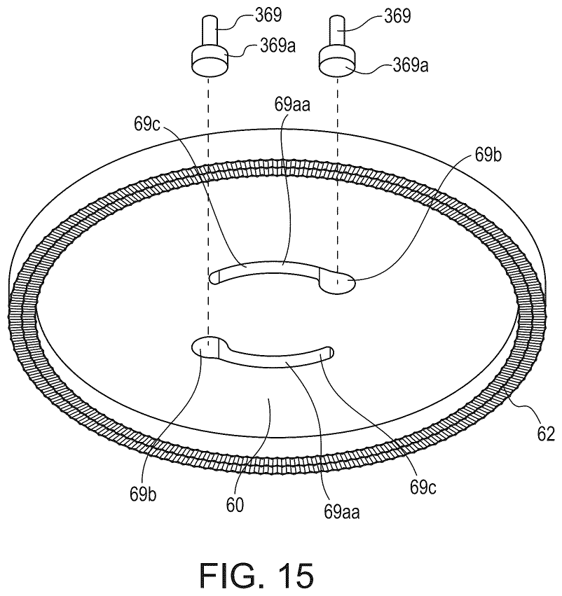

In other embodiments, such as the alternative embodiment depicted in FIG. 15, the pressing plate 60 may be removably retained to the second shaft 51 with other structures (to still allow the pressing plate 60 to be installed and removed without tools—such as via a plurality of studs 369 that extend from the second shaft 51 (either directly or indirectly) that are received with corresponding curved slots 69aa, preferably with diameters larger than the heads 369a of the studs 369 at an end 69b and then smaller width than the head along the remainder of the slots 69c, to allow the pressing plate 60 to be placed upon the studs 369 and then rotated to retain the pressing plate 60 upon the studs 369).

In some embodiments, the pressing plate 60 may include one or several apertures 69a that align with the central portion 63 to reduce the weight and material used to form the pressing plate 60.

The device 10 is configured to be used as follows and is configured to receive dough 2000 and preferably pre-flattened dough thereon, either directly upon the resting surface 103 or upon a pan (not shown) that is placed upon the resting surface 103.

As discussed above, the device 10 is configured to finish a dough that is configured to include fillings. The fillings may be elongate cheese or shredded cheese, and/or, pizza toppings (e.g. peperoni or sausage or other proteins, vegetables, spices, liquids (e.g. marinara sauce, ranch dressing, or the like)) that is desired to be included within the crust of the cooked pizza around the entire circumference of the pizza, or portions of the circumference of the pizza.

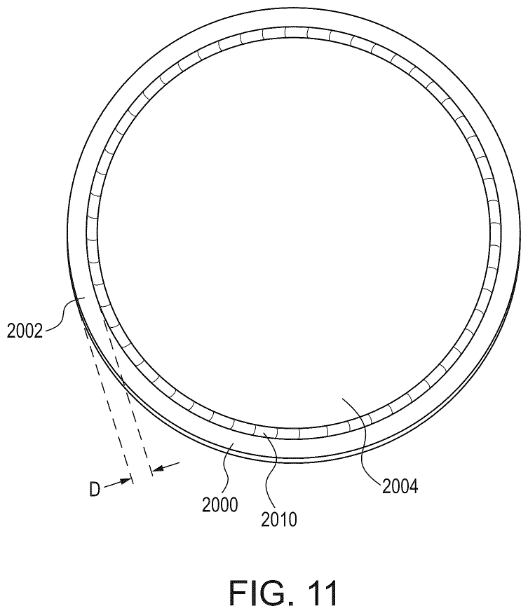

Prior to presenting the dough 2000 upon the device 10 the dough is prepared as depicted in FIG. 11. The dough 2000 is flattened using conventional methods to a size (i.e. a diameter for circular pizzas, rectangular or square size for those shapes of pizzas) that is larger than the final desired pizza, and the desired fillings 2010, such as cheese and/or other toppings (discussed above) are placed in a circle (or shape of the final pizza shape) around the outer periphery of the dough 2010, but spaced distance D (FIG. 11) away from the outer edge to leave some dough 2002 outboard of the cheese/toppings 2010. The dough may be then placed upon the resting surface 103 (FIG. 13), which causes the extended dough portion 2002 to rest upon the edge of the retaining edge 104.

In other methods, the extended dough portion 2002 may be wrapped around the fillings 2010 such that the extended portion 2002 covers the fillings 2010 and includes a double width portion 2008 inboard of the fillings 2010. In methods discussed above, the extended portion 2002 is folded over the fillings 2010 when upon the retaining surface 103 to establish the double width portion 2008.

The pressing plate 60 is then placed concentrically with the dough 2000 and the resting surface 103 by manipulating the handle 32 to cause the arm 20 to rotate about the housing 20. When the arm 20 is positioned above and concentric with the support 100 (as established by the contact between the stop member 39 and the shaft housing 36a), the handle 32 may be manipulated to pivot the lever 30 vertically with respect to the arm 20, which causes the second shaft 51 to move to move (such as by translation) the pressing plate 60 downward toward the support 100. As the pressing plate 60 moves downward and approaches the dough, the outer circumferential portion 62 is aligned above the double width portion 2008 of the dough that rests upon the support. With continued downward motion the circumferential portion 62 (and specifically the jagged portion 62a) contacts the double width portion 2008 and with continued motion compresses the double width portion 2008 until the lever 30 reaches its limit of travel.

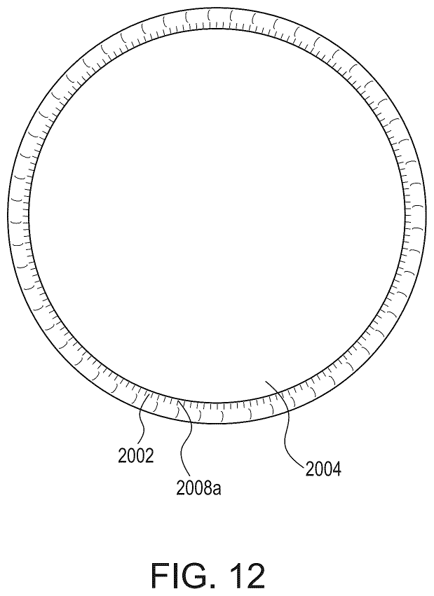

The compression of the double width portion 2008 serves to “lock in” the fillings 2010 within the outer edge of the dough 2000, as depicted in FIG. 14. The jagged portion 62a establishes local indentations 2008a upon the dough 2000 as depicted schematically in FIG. 12. In some embodiments, the distance 10 is sized such that when the pressing plate 60 is in the vertical lowest position, the tips of the jagged portion 62a is at a distance (Y) that is less than double the thickness P of the dough 2000 to be processed by the device, but may be greater than the thickness P of the dough 2000.

After the lever 30 has reached the limit of its travel, the user maintains the lever in this position for a short period of time (e.g. a few seconds) and then pivots the handle 32 in the opposite vertical direction, which causes the second shaft 51 and therefore the pressing plate 60 to lift upward away from the dough 2000. The handle 32 is rotated until the limit of rotation of the lever 30 with respect to the arm 20 is reached, such as by the first end 30a of the lever contacting the arm (either directly or indirectly as discussed above). At this position the entire pressing plate 60 is vertically above the support 100 with additional clearance above the support to allow for the newly formed crust of the dough 2000 (which is the height tice the thickness P of the dough as well as the thickness of the fillings 2010 within the dough).

The user then rotates the handle 32 to allow the arm 20 (and pressing plate 60) to rotate away from alignment with the support 100. With sufficient rotation, the stop member 39 engages the shaft housing 36a to prevent further rotation. At this position the pressing plate 60 is no longer above the support 100 to allow the dough 2000 to be taken off of the support for further assembly of the desired pizza (e.g. cheese, sauce, toppings upon the dough 2000 inboard of the formed crust portion and baking. In some embodiments, the pressing plate 60 may be partially vertically above the support plate 100 but still in a position to allow the dough 2000 to be ergonomically removed from the support plate 100.

The term “about” is specifically defined herein to include a range that includes the reference value and plus or minus 5% of the reference value. The term “substantially the same” is satisfied when the width of the end surfaces of the holes are both within the above range. The term “substantially parallel” is satisfied when the two items being compared are exactly parallel or disposed with an angle between the two of less than 5 or 10 degrees. The items being compared may be substantially parallel and have planar shapes, as well as when the items are generally planar (i.e. they extend along a plane but have one or more portions that do not extend within the plane), such as items with portions of relatively minor curvature or interior angles where a plane can be readily fit along the item between its end portions and through a significant percentage of the item. The term “overwhelming majority” is defined herein to mean 80% or more (and including all) of the items within the group being described.

While the preferred embodiments of the disclosed have been described, it should be understood that the invention is not so limited and modifications may be made without departing from the disclosure. The scope of the disclosure is defined by the appended claims, and all devices that come within the meaning of the claims, either literally or by equivalence, are intended to be embraced therein.

The specification and be readily understood with reference to the following representative paragraphs:

Representative Paragraph 1: A movable pressing device, comprising:
a base comprising a support with a retaining edge;
a pivoting mechanism that is fixed to the base;
a pressing plate operatively engaged with the pivoting mechanism, the pressing plate is horizontally movable with respect to the base with movement of the pivoting mechanism, and the pressing plate is vertically movable with respect to the pivoting mechanism, wherein the pressing plate comprises an outer edge portion that extends around an outer circumference of a bottom surface of the pressing plate, the outer edge portion comprises a jagged pattern along a bottom surface thereof about the outer edge portion, the pressing plate further comprises a central portion of the bottom surface of the pressing plate that extends radially inboard of the outer edge portion and through a center of the pressing plate, wherein the central portion is upwardly recessed above the jagged pattern of the outer edge portion.

Representative Paragraph 2: The movable pressing device of Representative Paragraph 1, wherein the pivoting mechanism comprises an arm that is rotatably mounted to the base, wherein the arm supports the pressing plate such that the pressing plate is vertically movable with respect to the arm.

Representative Paragraph 3: The movable pressing device of Representative Paragraph 2, wherein the pivoting mechanism further comprises a shaft that is rotatable with respect to the base as the arm rotates with respect to the base, the pivoting mechanism further comprises a stop member that engages the base at a first position of the base when the arm is in a position where the pressing plate is concentrically aligned with the support, and the stop member additionally engages the base at different second position upon the base when the arm is rotated away from the support and wherein the engagement between the stop member and the second position of the base establishes a range of pivoting of the arm with respect to the base away from the position were the pressing plate is concentrically aligned with the support.

Representative Paragraph 4: The movable pressing device of any one of Representative Paragraphs 2 or 3, wherein the base comprises a resistance block with an aperture therethrough through which the shaft extends, wherein the aperture and shaft mate with a tight fit such that a force of friction between the shaft and a surface defining the aperture provides resistance to rotation of the shaft with respect to the resistance block.

Representative Paragraph 5: The movable pressing device of any one of Representative Paragraphs 1-4, further comprising a lever with a pin that pivotably connects the lever to the arm, wherein the lever comprises a handle that extends in a first direction away from pivotable connection, and the lever supports a counterweight on an opposite side of the pin from the handle, wherein the lever is rotatable between a first position were the pressing plate is at its highest vertical position and a second position where the pressing plate is at its lowest vertical position.

Representative Paragraph 6: The movable pressing device of Representative Paragraph 5, further comprising a second shaft that is vertically mounted with respect to the lever, the second shaft is constrained with respect to the lever such that the second shaft translates vertically when the lever rotates about the pin, wherein the second shaft is fixed to the pressing plate such that the pressing plate translates vertically as the second shaft translates vertically.

Representative Paragraph 7: The movable pressing device of Representative Paragraph 6, wherein the arm supports a second resistance block with an aperture therethrough through which the second shaft extends, wherein the aperture and the second shaft mate with a tight fit such that a force of friction between the second shaft and a surface defining the aperture provides resistance to vertical movement of the second shaft with respect to the resistance block.

Representative Paragraph 8: The movable pressing device of Representative Paragraph 7, wherein the lever is configured such that when the counterweight rests upon the arm the handle and the pressing plate are in a maximum vertically raised position, and when the lever is rotated about the pin such that the handle and pressing plate can be urged vertically downward which raises the counterweight off of the arm.

Representative Paragraph 9: The movable pressing device of Representative Paragraph 8, wherein the counterweight is sized and positioned upon the lever with respect to the pin and the pressing plate and the second shaft act upon the lever on an opposite side of the pin such that torque created upon the lever due to the gravitational force of the counterweight is balanced with torque created upon the lever due to the gravitational force of the pressing plate as limited by the frictional force between the second shaft and the second resistance block such that the lever remains stationary when in the second position.

Representative Paragraph 10: The movable pressing device of Representative Paragraph 5, wherein the pivoting mechanism causes the pressing plate to move between a first position where the pressing plate is concentrically aligned with the support and a second position where the arm is rotated away from the support, wherein when the pressing plate is in the first position and the lever is in the second position, the jagged pattern of the outer edge portion is positioned vertically below a top surface of the retaining edge.

Representative Paragraph 11: The movable pressing device of Representative Paragraph 6, wherein the pressing plate is removably fixed to the second shaft with a threaded connection.

Representative Paragraph 12: The movable pressing device of any one of Representative Paragraphs 1-11, wherein the support is circular and extends horizontally, wherein the central portion of the support is flat and the retaining edge extends upwardly from the central portion, wherein the retaining edge is annular and includes constant inner and outer diameters along its circumference.

Representative Paragraph 13: The movable pressing device of Representative Paragraph 12, wherein the retaining edge includes an inner surface that is at an obtuse angle to a line that extends from the a bottom of the inner surface toward a center point of the support.

Representative Paragraph 14: The movable pressing device of any one of Representative Paragraphs 12-13, wherein the support is removable from the base by lifting the pressing plate vertically from the base.

Representative Paragraph 15: The movable pressing device of any one of Representative Paragraphs 10-14, wherein when the pressing plate is in the first position and the lever is in the second position, bottom-most tips of the jagged portion are spaced at a distance away from a horizontal central portion of the support lower than a height of the retaining edge above the resting surface.

Representative Paragraph 16: The movable pressing device of Representative Paragraph 15, wherein the distance is less than twice a nominal thickness of a dough that is configured to be received upon the resting surface.

Representative Paragraph 17: A method of preparing dough for a pizza, comprising:
flattening dough to a thickness that is desired for baking as a pizza and preparing the dough so that it is approximately circular;
placing an one or more fillings around the flattened dough proximate to an outer circumferential edge of the dough but inboard of the outer circumferential edge a predetermined distance;
overlapping the one or more fillings resting upon the flattened dough with the dough portion that forms the outer circumferential edge to cover the elongate string of cheese;
pulling the outer circumferential edge of the dough until the pulled outer circumferential edge contacts dough that is radially inboard of the placed string of cheese around the circumference of the dough;
placing the flattened dough upon a support of a pressing device, the pressing device comprising:
   a base that receives the support,
   a pivoting mechanism comprising an arm, the pivoting mechanism is fixed to the base and operatively supports a pressing plate, the pressing plate is horizontally movable with respect to the base with movement of the pivoting mechanism, between a first horizontal position where the pressing plate is concentrically aligned with the support, and a second horizontal position where the pressing plate is moved away from a position of concentric alignment with the support,
   the pressing plate comprises an outer edge portion that extends around an outer circumference of a bottom surface of the pressing plate, wherein the outer edge portion comprises a jagged pattern along a bottom surface thereof about the outer edge portion, wherein the pressing plate comprises a central portion of the bottom surface that extends radially inboard of the outer edge portion and through a center of the pressing plate, wherein the central portion is upwardly recessed above the jagged pattern of the outer edge portion,
   the pivoting mechanism further comprises a lever that is pivotably connected to the arm, wherein rotation of the lever causes the pressing plate to vertically move between a first vertical position where the pressing plate is vertically above the support and a second horizontal position where the pressing plate is vertically lower wherein a portion of the pressing plate is lower than at least a top portion of the support;
wherein the flattened dough is placed upon the support when the pressing plate is in the first vertical position and the second horizontal position;
manipulating the pivoting mechanism to rotate the pressing plate to the first horizontal position, and manipulating the pivoting mechanism so that the pressing plate lowers to the second vertical position, wherein when in the second vertical position the jagged pattern engages the wrapped dough that initially formed the initial outer circumferential edge of the flattened dough;
allowing the jagged pattern to press into the dough, and then manipulating the pivoting mechanism such that the pressing plate returns lifts to first vertical position and rotates to the second horizontal position; and
removing the dough from the support.

Representative Paragraph 18: The method of Representative Paragraph 17, wherein the lever further comprises a handle and a counterweight, wherein the handle and the counterweight are positioned on opposite sides of a pinned connection between the lever and an arm, wherein the arm is pivotably connected to the base.

Representative Paragraph 19: The method of Representative Paragraph 18, further comprising manipulating the handle to rotate the pressing plate between the first and second horizontal positions and to move the pressing plate between the first and second vertical positions.

Representative Paragraph 20: The method of Representative Paragraph 19, further comprising a second shaft that is vertically mounted with respect to the lever, the second shaft is constrained with respect to the lever such that the second shaft translates vertically when the lever rotates, wherein the pressing plate is fixed to the second shaft,
wherein the lever supports a resistance block with an aperture therethrough through which the second shaft extends, wherein the second shaft and the second shaft mate with a tight fit such that a force of friction between the second shaft and a surface defining the aperture provides frictional resistance to vertical movement of the second shaft with respect to the resistance block,
wherein the counterweight is sized and positioned upon the lever on a first side with respect to the pinned connection and an operative engagement between the second shaft and the lever is positioned on an opposite second side of the pinned connection from the counterweight such that torque created upon the lever due to the gravitational force of the counterweight is balanced with torque created upon the lever due to the gravitational force of the pressing plate as limited by the frictional force between the second shaft and the second resistance block such that the lever remains stationary when in the second vertical position.

Representative Paragraph 21: The method of Representative Paragraph 20, wherein the base comprises a second resistance block and the arm of the pivoting mechanism is fixed to a second shaft that extends through an aperture in the second resistance block, wherein the aperture of the second resistance block and the second shaft mate with a tight fit such that a force of friction between the second shaft and a surface defining the aperture provides resistance to rotation of the second shaft with respect to the resistance block, and therefore resistance to rotation of the arm with respect to the base.

Representative Paragraph 22: A movable pressing device, comprising:
a base comprising a support with a retaining edge;
a pivoting mechanism that is fixed to the base;
a pressing plate operatively engaged with the pivoting mechanism, the pressing plate is horizontally movable with respect to the base with movement of the pivoting mechanism, and the pressing plate is vertically movable with respect to the pivoting mechanism, wherein the pressing plate comprises an outer edge portion that extends around an outer circumference of a bottom surface of the pressing plate, the outer edge portion comprises a jagged pattern along a bottom surface thereof about the outer edge portion, the pressing plate further comprises a central portion of the bottom surface of the pressing plate that extends radially inboard of the outer edge portion and through a center of the pressing plate,
further comprising a lever with a pin that pivotably connects the lever to the arm, wherein the lever comprises a handle that extends in a first direction away from pivotable connection, and the lever supports a counterweight on an opposite side of the pin from the handle, wherein the lever is rotatable between a first position were the pressing plate is at its highest vertical position and a second position where the pressing plate is at its lowest vertical position.

Representative Paragraph 23: The movable pressing device of Representative Paragraph 22, wherein the pivoting mechanism comprises an arm that is rotatably mounted to the base, wherein the arm supports the pressing plate such that the pressing plate is vertically movable with respect to the arm.

Representative Paragraph 24: The movable pressing device of Representative Paragraph 23, wherein the pivoting mechanism further comprises a shaft that is rotatable with respect to the base as the arm rotates with respect to the base, the pivoting mechanism further comprises a stop member that engages the base at a first position of the base when the arm is in a position where the pressing plate is concentrically aligned with the support, and the stop member additionally engages the base at different second position upon the base when the arm is rotated away from the support and wherein the engagement between the stop member and the second position of the base establishes a range of pivoting of the arm with respect to the base away from the position were the pressing plate is concentrically aligned with the support.

Representative Paragraph 25: The movable pressing device of any one of Representative Paragraphs 23 or 24, wherein the base comprises a resistance block with an aperture therethrough through which the shaft extends, wherein the aperture and shaft mate with a tight fit such that a force of friction between the shaft and a surface defining the aperture provides resistance to rotation of the shaft with respect to the resistance block.

Representative Paragraph 26: The movable pressing device of any one of Representative Paragraphs 22-25, further comprising a second shaft that is vertically mounted with respect to the lever, the second shaft is constrained with respect to the lever such that the second shaft translates vertically when the lever rotates about the pin, wherein the second shaft is fixed to the pressing plate such that the pressing plate translates vertically as the second shaft translates vertically.

Representative Paragraph 27: The movable pressing device of Representative Paragraph 26, wherein the arm supports a second resistance block with an aperture therethrough through which the second shaft extends, wherein the aperture and the second shaft mate with a tight fit such that a force of friction between the second shaft and a surface defining the aperture provides resistance to vertical movement of the second shaft with respect to the resistance block.

Representative Paragraph 28: The movable pressing device of Representative Paragraph 27, wherein the lever is configured such that when the counterweight rests upon the arm the handle and the pressing plate are in a maximum vertically raised position, and when the lever is rotated about the pin such that the handle and pressing plate can be urged vertically downward which raises the counterweight off of the arm.

Representative Paragraph 29: The movable pressing device of Representative Paragraph 28, wherein the counterweight is sized and positioned upon the lever with respect to the pin and the pressing plate and the second shaft act upon the lever on an opposite side of the pin such that torque created upon the lever due to the gravitational force of the counterweight is balanced with torque created upon the lever due to the gravitational force of the pressing plate as limited by the frictional force between the second shaft and the second resistance block such that the lever remains stationary when in the second position.

Representative Paragraph 30: The movable pressing device of any one of Representative Paragraphs 22-29, wherein the pivoting mechanism causes the pressing plate to move between a first position where the pressing plate is concentrically aligned with the support and a second position where the arm is rotated away from the support, wherein when the pressing plate is in the first position and the lever is in the second position, the jagged pattern of the outer edge portion is positioned vertically below a top surface of the retaining edge.

Representative Paragraph 31: The movable pressing device of any one of Representative Paragraphs 26-30, wherein the pressing plate is removably fixed to the second shaft with a threaded connection.

Representative Paragraph 32: The movable pressing device of any one of Representative Paragraphs 22-31, wherein the support is circular and extends horizontally, wherein the central portion of the support is flat and the retaining edge extends upwardly from the central portion, wherein the retaining edge is annular and includes constant inner and outer diameters along its circumference.

Representative Paragraph 33: The movable pressing device of Representative Paragraph 32, wherein the retaining edge includes an inner surface that is at an obtuse angle to a line that extends from the a bottom of the inner surface toward a center point of the support.

Representative Paragraph 34: The movable pressing device of any one of Representative Paragraphs 32-33, wherein the support is removable from the base by lifting the pressing plate vertically from the base.

Representative Paragraph 35: The movable pressing device of any one of Representative Paragraphs 30-34, wherein when the pressing plate is in the first position and the lever is in the second position, bottom-most tips of the jagged portion are spaced at a distance away from a horizontal central portion of the support lower than a height of the retaining edge above the resting surface.

Representative Paragraph 36: The movable pressing device of Representative Paragraph 35, wherein the distance is less than twice a nominal thickness of a dough that is configured to be received upon the resting surface.

Representative Paragraph 37: A method of preparing dough for a pizza, comprising:
flattening dough to a thickness that is desired for baking as a pizza and preparing the dough so that it is approximately circular;
placing an one or more fillings around the flattened dough proximate to an outer circumferential edge of the dough but inboard of the outer circumferential edge a predetermined distance;
overlapping the one or more fillings resting upon the flattened dough with the dough portion that forms the outer circumferential edge to cover the elongate string of cheese;
pulling the outer circumferential edge of the dough until the pulled outer circumferential edge contacts dough that is radially inboard of the placed string of cheese around the circumference of the dough;
placing the flattened dough upon a support of a pressing device, the pressing device comprising:
   a base that receives the support,
   a pivoting mechanism comprising an arm, the pivoting mechanism is fixed to the base and operatively supports a pressing plate, the pressing plate is horizontally movable with respect to the base with movement of the pivoting mechanism, between a first horizontal position where the pressing plate is concentrically aligned with the support, and a second horizontal position where the pressing plate is moved away from a position of concentric alignment with the support,
   the pressing plate comprises an outer edge portion that extends around an outer circumference of a bottom surface of the pressing plate, wherein the outer edge portion comprises a jagged pattern along a bottom surface thereof about the outer edge portion, wherein the pressing plate comprises a central portion of the bottom surface that extends radially inboard of the outer edge portion and through a center of the pressing plate,
   the pivoting mechanism further comprises a lever that is pivotably connected to the arm, wherein rotation of the lever causes the pressing plate to vertically move between a first vertical position where the pressing plate is vertically above the support and a second horizontal position where the pressing plate is vertically lower wherein a portion of the pressing plate is lower than at least a top portion of the support;
wherein the flattened dough is placed upon the support when the pressing plate is in the first vertical position and the second horizontal position;
manipulating the pivoting mechanism to rotate the pressing plate to the first horizontal position, and manipulating the pivoting mechanism so that the pressing plate lowers to the second vertical position, wherein when in the second vertical position the jagged pattern engages the wrapped dough that initially formed the initial outer circumferential edge of the flattened dough;
allowing the jagged pattern to press into the dough, and then manipulating the pivoting mechanism such that the pressing plate returns lifts to first vertical position and rotates to the second horizontal position; and
removing the dough from the support.

Representative Paragraph 38: The method of Representative Paragraph 37, wherein the lever further comprises a handle and a counterweight, wherein the handle and the counterweight are positioned on opposite sides of a pinned connection between the lever and an arm, wherein the arm is pivotably connected to the base.

Representative Paragraph 39: The method of Representative Paragraph 38, further comprising manipulating the handle to rotate the pressing plate between the first and second horizontal positions and to move the pressing plate between the first and second vertical positions.

Representative Paragraph 40: The method of Representative Paragraph 39, further comprising a second shaft that is vertically mounted with respect to the lever, the second shaft is constrained with respect to the lever such that the second shaft translates vertically when the lever rotates, wherein the pressing plate is fixed to the second shaft,
wherein the lever supports a resistance block with an aperture therethrough through which the second shaft extends, wherein the second shaft and the second shaft mate with a tight fit such that a force of friction between the second shaft and a surface defining the aperture provides frictional resistance to vertical movement of the second shaft with respect to the resistance block,
wherein the counterweight is sized and positioned upon the lever on a first side with respect to the pinned connection and an operative engagement between the second shaft and the lever is positioned on an opposite second side of the pinned connection from the counterweight such that torque created upon the lever due to the gravitational force of the counterweight is balanced with torque created upon the lever due to the gravitational force of the pressing plate as limited by the frictional force between the second shaft and the second resistance block such that the lever remains stationary when in the second vertical position.

Representative Paragraph 41: The method of Representative Paragraph 40, wherein the base comprises a second resistance block and the arm of the pivoting mechanism is fixed to a second shaft that extends through an aperture in the second resistance block, wherein the aperture of the second resistance block and the second shaft mate with a tight fit such that a force of friction between the second shaft and a surface defining the aperture provides resistance to rotation of the second shaft with respect to the resistance block, and therefore resistance to rotation of the arm with respect to the base.

1. A movable pressing device, comprising:
a base comprising a support with a retaining edge;
a pivoting mechanism that is fixed to the base;
a pressing plate operatively engaged with the pivoting mechanism, the pressing plate is horizontally movable with respect to the base with movement of the pivoting mechanism, and the pressing plate is vertically movable with respect to the pivoting mechanism, wherein the pressing plate comprises an outer edge portion that extends around an outer circumference of a bottom surface of the pressing plate, the outer edge portion comprises a jagged pattern along a bottom surface thereof about the outer edge portion, the pressing plate further comprises a central portion of the bottom surface of the pressing plate that extends radially inboard of the outer edge portion and through a center of the pressing plate, wherein the central portion is upwardly recessed above the jagged pattern of the outer edge portion.

2. The movable pressing device of claim 1, wherein the pivoting mechanism comprises an arm that is rotatably mounted to the base, wherein the arm supports the pressing plate such that the pressing plate is vertically movable with respect to the arm.

3. The movable pressing device of claim 2, wherein the pivoting mechanism further comprises a shaft that is rotatable with respect to the base as the arm rotates with respect to the base, the pivoting mechanism further comprises a stop member that engages the base at a first position of the base when the arm is in a position where the pressing plate is concentrically aligned with the support, and the stop member additionally engages the base at different second position upon the base when the arm is rotated away from the support and wherein the engagement between the stop member and the second position of the base establishes a range of pivoting of the arm with respect to the base away from the position were the pressing plate is concentrically aligned with the support.

4. The movable pressing device of claim 2, wherein the base comprises a resistance block with an aperture therethrough through which the shaft extends, wherein the aperture and shaft mate with a tight fit such that a force of friction between the shaft and a surface defining the aperture provides resistance to rotation of the shaft with respect to the resistance block.

5. The movable pressing device of claim 1, further comprising a lever with a pin that pivotably connects the lever to the arm, wherein the lever comprises a handle that extends in a first direction away from pivotable connection, and the lever supports a counterweight on an opposite side of the pin from the handle, wherein the lever is rotatable between a first position were the pressing plate is at its highest vertical position and a second position where the pressing plate is at its lowest vertical position.

6. The movable pressing device of claim 5, further comprising a second shaft that is vertically mounted with respect to the lever, the second shaft is constrained with respect to the lever such that the second shaft translates vertically when the lever rotates about the pin, wherein the second shaft is fixed to the pressing plate such that the pressing plate translates vertically as the second shaft translates vertically.

7. The movable pressing device of claim 6, wherein the arm supports a second resistance block with an aperture therethrough through which the second shaft extends, wherein the aperture and the second shaft mate with a tight fit such that a force of friction between the second shaft and a surface defining the aperture provides resistance to vertical movement of the second shaft with respect to the resistance block.

8. The movable pressing device of claim 7, wherein the lever is configured such that when the counterweight rests upon the arm the handle and the pressing plate are in a maximum vertically raised position, and when the lever is rotated about the pin such that the handle and pressing plate can be urged vertically downward which raises the counterweight off of the arm.

9. The movable pressing device of claim 8, wherein the counterweight is sized and positioned upon the lever with respect to the pin and the pressing plate and the second shaft act upon the lever on an opposite side of the pin such that torque created upon the lever due to the gravitational force of the counterweight is balanced with torque created upon the lever due to the gravitational force of the pressing plate as limited by the frictional force between the second shaft and the second resistance block such that the lever remains stationary when in the second position.

10. The movable pressing device of claim 5, wherein the pivoting mechanism causes the pressing plate to move between a first position where the pressing plate is concentrically aligned with the support and a second position where the arm is rotated away from the support, wherein when the pressing plate is in the first position and the lever is in the second position, the jagged pattern of the outer edge portion is positioned vertically below a top surface of the retaining edge.

11. The movable pressing device of claim 6, wherein the pressing plate is removably fixed to the second shaft with a threaded connection.

12. The movable pressing device of claim 1, wherein the support is circular and extends horizontally, wherein the central portion of the support is flat and the retaining edge extends upwardly from the central portion, wherein the retaining edge is annular and includes constant inner and outer diameters along its circumference.

13. The movable pressing device of claim 12, wherein the retaining edge includes an inner surface that is at an obtuse angle to a line that extends from the a bottom of the inner surface toward a center point of the support.

14. The movable pressing device of claim 12, wherein the support is removable from the base by lifting the pressing plate vertically from the base.

15. The movable pressing device of claim 10, wherein when the pressing plate is in the first position and the lever is in the second position, bottom-most tips of the jagged portion are spaced at a distance away from a horizontal central portion of the support lower than a height of the retaining edge above the resting surface.

16. The movable pressing device of claim 15, wherein the distance is less than twice a nominal thickness of a dough that is configured to be received upon the resting surface.

17. A method of preparing dough for a pizza, comprising:
flattening dough to a thickness that is desired for baking as a pizza and preparing the dough so that it is approximately circular;
placing an one or more fillings around the flattened dough proximate to an outer circumferential edge of the dough but inboard of the outer circumferential edge a predetermined distance;
overlapping the one or more fillings resting upon the flattened dough with the dough portion that forms the outer circumferential edge to cover the elongate string of cheese;
pulling the outer circumferential edge of the dough until the pulled outer circumferential edge contacts dough that is radially inboard of the placed string of cheese around the circumference of the dough;
placing the flattened dough upon a support of a pressing device, the pressing device comprising:
a base that receives the support,
a pivoting mechanism comprising an arm, the pivoting mechanism is fixed to the base and operatively supports a pressing plate, the pressing plate is horizontally movable with respect to the base with movement of the pivoting mechanism, between a first horizontal position where the pressing plate is concentrically aligned with the support, and a second horizontal position where the pressing plate is moved away from a position of concentric alignment with the support,
the pressing plate comprises an outer edge portion that extends around an outer circumference of a bottom surface of the pressing plate, wherein the outer edge portion comprises a jagged pattern along a bottom surface thereof about the outer edge portion, wherein the pressing plate comprises a central portion of the bottom surface that extends radially inboard of the outer edge portion and through a center of the pressing plate, wherein the central portion is upwardly recessed above the jagged pattern of the outer edge portion,
the pivoting mechanism further comprises a lever that is pivotably connected to the arm, wherein rotation of the lever causes the pressing plate to vertically move between a first vertical position where the pressing plate is vertically above the support and a second horizontal position where the pressing plate is vertically lower wherein a portion of the pressing plate is lower than at least a top portion of the support;
wherein the flattened dough is placed upon the support when the pressing plate is in the first vertical position and the second horizontal position;
manipulating the pivoting mechanism to rotate the pressing plate to the first horizontal position, and manipulating the pivoting mechanism so that the pressing plate lowers to the second vertical position, wherein when in the second vertical position the jagged pattern engages the wrapped dough that initially formed the initial outer circumferential edge of the flattened dough;
allowing the jagged pattern to press into the dough, and then manipulating the pivoting mechanism such that the pressing plate returns lifts to first vertical position and rotates to the second horizontal position; and
removing the dough from the support.

18. The method of claim 17, wherein the lever further comprises a handle and a counterweight, wherein the handle and the counterweight are positioned on opposite sides of a pinned connection between the lever and an arm, wherein the arm is pivotably connected to the base.

19. The method of claim 18, further comprising manipulating the handle to rotate the pressing plate between the first and second horizontal positions and to move the pressing plate between the first and second vertical positions.

20. The method of claim 19, further comprising a second shaft that is vertically mounted with respect to the lever, the second shaft is constrained with respect to the lever such that the second shaft translates vertically when the lever rotates, wherein the pressing plate is fixed to the second shaft,
wherein the lever supports a resistance block with an aperture therethrough through which the second shaft extends, wherein the second shaft and the second shaft mate with a tight fit such that a force of friction between the second shaft and a surface defining the aperture provides frictional resistance to vertical movement of the second shaft with respect to the resistance block,
wherein the counterweight is sized and positioned upon the lever on a first side with respect to the pinned connection and an operative engagement between the second shaft and the lever is positioned on an opposite second side of the pinned connection from the counterweight such that torque created upon the lever due to the gravitational force of the counterweight is balanced with torque created upon the lever due to the gravitational force of the pressing plate as limited by the frictional force between the second shaft and the second resistance block such that the lever remains stationary when in the second vertical position.

21. The method of claim 20, wherein the base comprises a second resistance block and the arm of the pivoting mechanism is fixed to a second shaft that extends through an aperture in the second resistance block, wherein the aperture of the second resistance block and the second shaft mate with a tight fit such that a force of friction between the second shaft and a surface defining the aperture provides resistance to rotation of the second shaft with respect to the resistance block, and therefore resistance to rotation of the arm with respect to the base.
